(19) United States
(12) Patent Application Publication
(10) Pub. No.: US 2014/0326191 A1
(43) Pub. Date: Nov. 6, 2014

(54) TIGHTENABLE PET PAD

(71) Applicant: Jiangsu Zhongheng Pet Supplies Co., Ltd., Jiangsu (CN)

(72) Inventor: Bin QIU, Jiangsu (CN)

(73) Assignee: Jiangsu Zhongheng Pet Supplies Co., Ltd., Jiangsu (CN)

(21) Appl. No.: 14/269,610

(22) Filed: May 5, 2014

(30) Foreign Application Priority Data
May 6, 2013 (CN) 201320235808.9

(51) Int. Cl. A01K 1/01; A01K 1/015

(52) U.S. Cl. CPC A01K 1/0107; A01K 1/0157
USPC 119/161

(57) ABSTRACT

A tightenable pet pad has a surface layer and one or more tightenable members provided on the surface layer. The tightenable member is the cord. Two end sections of the cord are joined to the surface layer and a middle section between the two end sections is free of joining to the surface layer. Therefore, in the case when the pet pad needs to be cleaned or replaced, the cords can be pulled upwardly to tight the pet pad into a pocket shape. Thus, the pet excrement is completely pocketed up and easily put into the trash bin.

### CROSS REFERENCE TO RELATED APPLICATION

The present application is based on, and claims priority from, Chinese Application Number 201320235808.9, filed May 6, 2013, the disclosure of which is incorporated herein in its entirety.

### TECHNICAL FIELD

The present disclosure relates generally to a pad for pets and, specifically, to a tightenable pet pad.

### BACKGROUND

With the development of society and the improvement of living standards, people are constantly in pursuit of the spiritual life; while they are enjoying the material life. Pets become people's spiritual sustenance, to meet people's communication needs; and bring a lot of joy to people. Therefore, pets become more and more important in people's lives; and the requirement for pets' life quality is also becoming constantly higher. Due to the limitation of the living environment, pets may excrete anywhere. This not only increases people's cleaning work, but also affects the sanitation of people's living environment. Although the conventional absorbent pads for pets can make it easy for the pet to excrete, when people are cleaning the pet pads used by the pet, the excreta on the used pet pad may stain people's hands, and contaminate the environment as well. Thus, technical personnel of the pet supply manufacturers have improved the design of the existing pet absorbent pads. Although certain progresses have been made, they all so far do not solve the problems well.

### BRIEF DESCRIPTION OF THE DRAWINGS

The present disclosure will be further described in conjunction with drawings and embodiments. Aspects of the present disclosure are best understood from the following detailed description when read with the accompanying figures.

FIG. 1 is a schematic front view of an embodiment of a tightenable pet pad, which is a four sides straightly lifting and tightening type.

FIG. 2 is a schematic bottom view of the embodiment.

FIG. 3 is a schematic perspective view of the embodiment in a tightened state.

FIG. 4 is a schematic front view of an embodiment of a tightenable pet pad, which is a two sides straightly lifting and tightening type.

FIG. 5 is a schematic bottom view of the FIG. 4 embodiment.

FIG. 6 is a schematic perspective view of the FIG. 4 embodiment in a tightened state.

### DETAILED DESCRIPTION

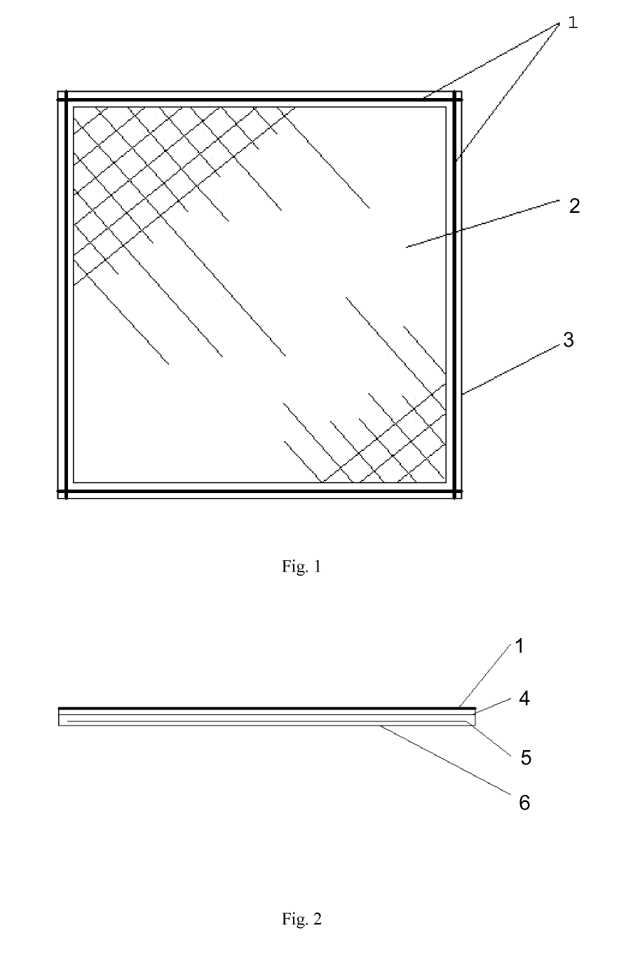

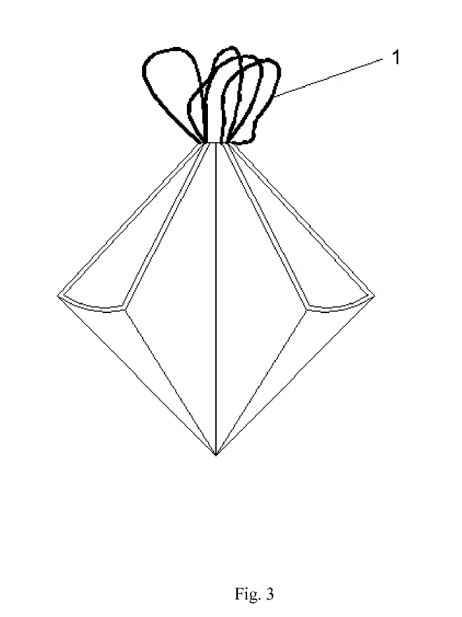

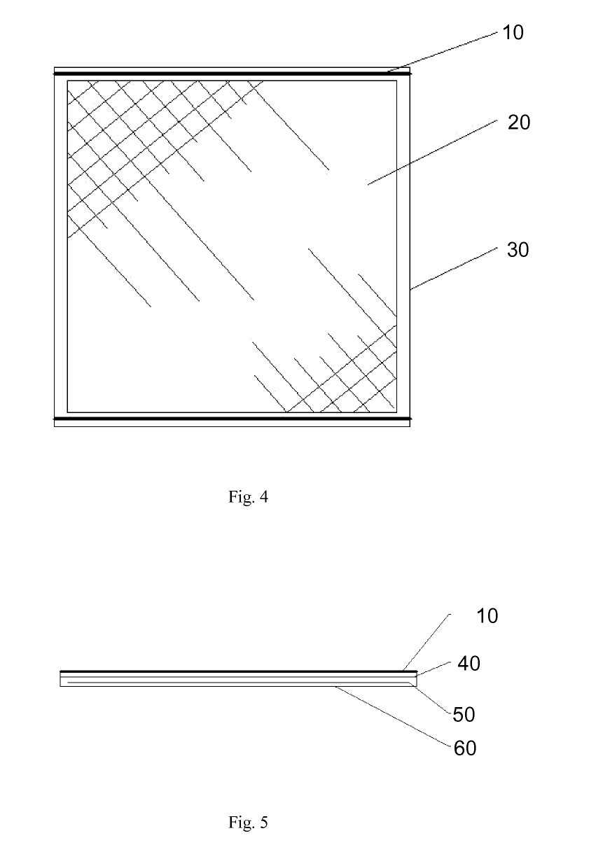

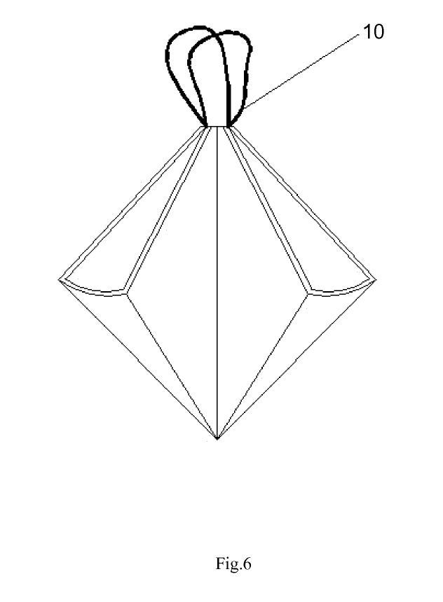

A first embodiment as described in FIGS. 1-3 is a four sides straight lifting and tightening type pet pad. A second embodiment as described in FIGS. 4-6 is a two straight lifting and tightening type pet pad. According to one or more embodiments of the present application, the tightenable pet pad is disposable.

In reference to FIGS. 1, 2 and 3: the tightenable pet pad according to the first embodiment includes a center part 2 and edge portions 3 surrounding the center part 2. The central part 2 defines an absorbing region of the pad. In at least some embodiments, the tightenable pet pad according to one or more embodiments is parallelogram-shaped. In some other embodiments, the tightenable pet pad according to one or more embodiments is other than parallelogram-shaped, e.g., circular, polygonal, elliptical, and similar.

As shown in FIG. 2, the tightenable pad includes a surface layer 4, an absorbent layer 5, and a film 6, which are stacked in a thickness direction of the tightenable absorbent pad. The surface layer 4, the absorbent layer 5, and the film 6 are disposed in a descending order from the top of the pad. The surface layer 4 defines a top of the absorbent pad and is configured to receive pet urine and feces, the film 6 defines a bottom of the absorbent pad. In one or more embodiment, the film 6 is made of a polyethylene film (PE film). The absorbent layer 5 is disposed between the surface layer 4 and the film 6. The surface layer 4 is fixed to the film 6 at edge portions 3 of the pad.

The first embodiment of the tightenable pet pad further includes tightening members 1 which are configured to be pulled upwardly to tighten the absorbent pad into a pocket shape. The tightening members 1 can be formed by cords. Each of the tightening members 1 has two end sections directly fixed at the corresponding edge portions 3 by glue or other manner of bonding. A middle section between the two ends of the corresponding tightening member is free of bonding to the surface layer.

FIG. 1 shows that the tightening elements 1 include first, second, third, and fourth tightening elements placed along four sides of the pad at the four edge portions 3. Two end sections of the first tightening element overlap an end section of the second tightening element and an end section of the fourth tightening element. The second and the fourth tightening elements are opposed to each other. FIG. 2 shows that the tightening elements 1 are disposed on top of the surface layer 4. Each of the tightening elements 1 extends continuously from one edge to another edge opposite to said one edge of the pad.

In the case when the absorbent pad needs to be replaced or cleaned, the tightening elements 1 are configured to be pulled upwardly together and away from the surface layer 4 so that the edge portions 3 of the pad are pulled toward each other and the absorbent pad is tightened into a pocket shape. Thus, the pet excrement on top of the surface layer 3 is pocketed and the absorbent pad can be easily picked up to be thrown away by grabbing the tightening elements 1.

In reference to FIGS. 4, 5 and 6: the tightenable pad according to the second embodiment includes a center part 20 and edges portions 30 surrounding the center part 20. The central part defines an absorbing region 20 of the pad.

As shown in FIG. 5, the tightenable pad includes a surface layer 40, an absorbent layer 50, and a film 60, which are stacked in a thickness direction of the tightenable pet pad. The absorbing region 20 includes the surface layer 40, the absorbent layer 50 and the film 60 stacked in a descending order from the top of the pad. The surface layer 40 defines a top of the absorbent pad and is configured to receive pet urine and feces. The film 60 defines a bottom of the pad. The absorbent layer 50 is located between the surface layer 40 and the film 60. The surface layer 40 is fixed to the film 60 at edge portions 30 of the pad.

The second embodiment of the tightenable pad further includes a pair of tightening members 10 which are configured to be pulled upwardly to tighten the pad into a pocket shape. The tightening members 10 can be formed by cords. Each of the tightening members 10 is disposed on a top of the surface layer 40. As shown in FIG. 4, a pair of tightening members 10 is disposed along two sides of the pad at the opposing edge portions 30. Each of the tightening members 1 has two ends directly fixed to the surface layer 40 at the corresponding edge portions 30 by adhesive or other suitable manner of fixing. A middle section between the two ends of the corresponding tightening member is free of fixing to the surface layer 40. Each of the tightening members 1 extends continuously from one edge to another edge opposite to said one edge of the pad.

In the case when the pad needs to be replaced or cleaned, the tightening members 10 are configured to be pulled upwardly together and away from the surface layer 40 so that the edge portions 30 carrying the tightening members 10 are pulled toward each other and the absorbent pad is tightened into a pocket shape. Thus, the pet excrement on top of the surface layer 30 is pocketed and the pad can be easily picked up to be thrown away by grabbing the tightening members 10.

The tightening members according to one or more embodiments can be made of different materials. The shape of the t pad is not limited to the square shape as illustrated in FIGS. 1-6.

In order to overcome the aforementioned shortcomings, one or more objects of one or more embodiments of the present disclosure is to provide a tightenable pet pad. In the case when the pet pad needs to be cleaned or replaced, the pad can be tightened into a pocket shape by directly pulling the tightenable members fixed to the pad. Thus the pet excrement is completely pocketed up and can be easily put into a trash bin. Therefore, the cleaning or replacing operation becomes quick and easy. Thus, the embodiments of the tightenable pet pad can reduce labor intensity of people's cleaning work.

In an aspect of one or more embodiments, a tightenable pet pad includes a surface layer, an absorbent layer, and a film. The central part of the pad is an absorbing region which is defined by the surface layer, absorbent layer, film stacked in a descending order. The absorbent layer is located between the surface layer and the film. The edges of the surface layer and of the film are fixed to each other to form the edge portions of the pad. A tightenable member is provided at the edge portions. In one of the embodiments, the tightenable member is a cord. Two ends of the cord are fixed to the pad edges.

Several advantages are provided by one or more embodiments including one or more of the following features: the cords are provided on the edges of the pet pad. In the case when the pet pad needs to be cleaned, the pet pad can be tightened into a pocket shape by pulling the cords of the pet pad. In this way, labor intensity of people's cleaning work is reduced and the cleaning time is saved.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A tightenable pet pad, comprising:
a surface layer; and
one or more tightening members disposed on the surface layer,
wherein
each of the tightening members includes two end sections and a middle section between the two end sections,
the end sections of the tightening member are joined to the surface layer, and
the middle section of the tightening member is free of bonding to the surface layer.

2. The tightenable pet pad according to claim 1, wherein each of the tightening members is a cord.

3. The tightenable pet pad according to claim 1, wherein the tightening members disposed on the surface layer extend along a peripheral edge of the pad.

4. The tightenable pet pad according to claim 3, wherein the tightening members include a first tightening member and a second tightening member, and the first and second tightening members overlap each other at the end sections.

5. The tightenable pet pad according to claim 4, wherein the overlapped end sections are bonded to the surface layer.

6. The tightenable pet pad according to claim 1, wherein each of the tightening member extends from an edge of the pad to another edge opposite to said edge of the pad.

7. The tightenable pet pad according to claim 1, further comprising an absorbent layer and a film,
wherein the absorbent layer is sandwiched between the surface layer and the film.

8. The tightenable pet pad according to claim 7, wherein the absorbent layer defines an absorbing region surrounded by the tightening members.

9. The tightenable pet pad according to claim 1, wherein the tightening members disposed on the surface layer extend along a pair of opposing edges of the pad.

10. The tightenable pet pad according to claim 9, wherein each of the tightening member is a cord.

11. The tightenable pet pad according to claim 9, further comprising an absorbent layer and a film,
wherein
the absorbent layer is sandwiched between the surface layer and the film, and
the absorbent layer defines an absorbing region between the pair of the tightening members.

12. The tightenable pet pad according to claim 1, wherein the tightenable pet pad is disposable.

13. The tightenable pet pad according to claim 1, wherein the one or more tightening members is two tightening members.

14. The tightenable pet pad according to claim 1, wherein the one or more tightening members is four tightening members.
